(19) United States
(12) Patent Application Publication
(10) Pub. No.: US 2004/0047356 A1
(43) Pub. Date: Mar. 11, 2004

(54) Network traffic monitoring

(76) Inventor: Blaine D. Bauer, Portland, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/236,402

(22) Filed: Sep. 6, 2002

(51) Int. Cl. H04L 12/28

(52) U.S. Cl. 370/401

(57) ABSTRACT

An intermediary network device, such as a router or other device through which network traffic passes or which may monitor passing network traffic, looks for suspicious network activity by a device. If a suspicious device is identified, then the suspicious device, assuming it supports management, may be managed to wholly or partially disable the device until its suspicious activity may be investigated. Assuming the intermediary passes network traffic for the suspicious device, in addition to or in lieu of management, the intermediary may be configured to wholly or to partially block communication to/from the suspicious device. Suspicious network activity may be identified through attempts to access network addresses not present in a routing table associated with the intermediary. Other indicia of suspicious activity are disclosed.

### FIELD OF THE INVENTION

The invention generally relates to network monitoring and network device management, and more particularly to a router monitoring routed devices for suspicious network activity indicative of a virus/worm infected or otherwise malfunctioning device.

### BACKGROUND

With the rapid proliferation of intranets and the Internet, the global communication network has become a veritable playground for malicious users to generate and spread viruses, worms, and other nefarious programs that typically result in extensive computer downtime and/or data loss.

To combat the viruses, worms, and other nefarious programs, scanning programs, often referred to as virus scanners, attempt to scan one's programs and data files for “signatures,” or sequences of data known to identify a malicious program. Although scanning has been very effective at combating known malicious programs, it is difficult to identify or stop an unknown malicious program, e.g., one that is not known to be spreading yet. Although some virus scanners attempt to apply heuristics or other metrics to identify program activity that is malicious program-like, their efficacy is limited.

Thus, for unknown malicious programs, scanning programs and data files is not an effective solution.

### BRIEF DESCRIPTION OF THE DRAWINGS

The features and advantages of the present invention will become apparent from the following detailed description of the present invention in which:

FIG. 1 illustrates a system according to one embodiment in which an infected device and a clean device communicate by way of a first network through an intermediary to a second network.

FIG. 2 illustrates one embodiment of a variation of the FIG. 1 embodiment.

FIG. 3 illustrates a flowchart according to one embodiment for monitoring network communication for suspicious activity

FIG. 4 illustrates a suitable computing environment in which certain aspects of the invention may be implemented.

### DETAILED DESCRIPTION

In the various illustrated embodiments, rather than relying on scanning program or data files, instead the operation of an infected device is monitored for suspicious activity. A fundamental requirement of a malicious program that spreads itself, e.g., infects other devices, is that the malicious program must locate other devices to which the malicious program can be spread. Since networked devices all have a network address (assumed herein to be an Internet Protocol (IP) address, but it will be appreciated one or more other addressing schemes may be employed), a common solution to locating other devices to infect is for the malicious program to scan through a network address range until another device capable of being infected is located. Often, the malicious program scans specific communication ports on an uninfected device for their availability for intrusion attempts. For example, a common tactic is to attempt to locate network devices having the windows file-sharing ports open for attack.

As will be discussed further below, such address and/or port scanning attempts may be identified and used to identify machines operating in a suspicious manner, and therefore which may be infected with a malicious program. And, through use of network management techniques, such as the Simple Network Management Protocol (SNMP), or products such as LANDesk by Intel Corporation of Santa Clara, Calif., a suspicious device may be partially or wholly shut down until the suspicion is resolved. In addition to managing the suspicious device, a router or other network intermediary which passes the suspicious device's network traffic may be instructed to block some (e.g., only certain port traffic) or all network traffic for the suspicious device until the device is repaired or determined to be operating correctly.

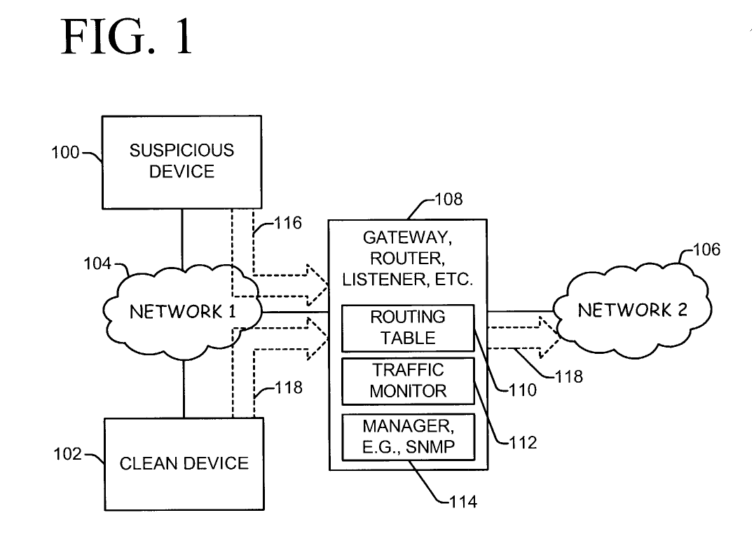

FIG. 1 illustrates a system according to one embodiment in which a suspicious device 100 and a clean device 102 communicate by way of a first network 104 to a second network 106 through an intermediary 108.

The suspicious device 100 is assumed to be possibly operating under the influence of a worm, virus or other such malicious program. The clean device 102 is assumed to be one operating normally. The first and second networks 104, 106 may be any variety or combination of networks, including an intranet, the Internet, a wireless network, or other network. The intermediary 108 is a device through which communication passes, or is a device that can monitor passing communication, and includes common access points such as a router, gateway, network address translator (NAT), etc., or it may be a network listener or “sniffer.” It will be appreciated by one skilled in the art that the described embodiments for the FIG. 1 devices are exemplary only, and other embodiments are contemplated.

In the illustrated embodiment, the intermediary 108 provides router functionality and is also configured to monitor network traffic to identify suspicious activity by a network device, such as the suspicious device 100. The intermediary comprises a routing table 110 tracking routes known to the intermediary and a traffic monitor 112 that looks for suspicious network activity. It will be appreciated that a network may comprise routers and other intermediaries that do not have a complete routing table for an entire network; in one embodiment, these routers or intermediaries forward-on requests for unknown addresses, where it is assumed there is at least one final intermediary having a complete routing table and that is therefore able to identify the suspicious network activity as discussed herein. Even if an intermediary has an incomplete routing table, in one embodiment, the routing table may be complete for a particular subnet of the network, and the intermediary may therefore be able to identify suspicious network activity for its subnet.

The intermediary 108 also comprises a manager 114, such as a SNMP component, remote operating system management component, or other network manager that may be used to shut down or otherwise partially or wholly disable a malfunctioning device, such as the suspicious device 100. For example, if the suspicious device has an infected web server communicating on port 80, then the suspicious device may be instructed to stop communicating over port 80, or it may be instructed to shut down its web server service (assuming an operating system, such as Linux or Windows, utilizing controllable services).

In one embodiment, the intermediary's 108 traffic monitor 112 identifies suspicious activity based on communication 116 attempts by the suspicious device 100 to reach nonexistent addresses in routing table 110. For example, a suspicious device will typically attempt a rapid search of a network address range to locate another device to infect. Since most networks are typically not fully populated, there are many unused network addresses. The intermediary, having a routing table 110 of valid addresses, can identify attempts to contact nonexistent addresses. If too many attempts are made within a certain (selectable) period of time, a conclusion may be drawn that the device making the attempts is infected with a virus, worm, or other malicious program attempting to get at other devices on a network. In another embodiment (not illustrated) in which a network is fully populated, the intermediary identifies address scanning as being suspicious network activity.

Thus, while legitimate network communication 118 from the clean device 102 is allowed to pass through the intermediary to network 2 106, the suspicious communication 116 from the suspicious host 100 is not allowed to pass. This suspicious communication may also be logged or stored for later retrieval and analysis.

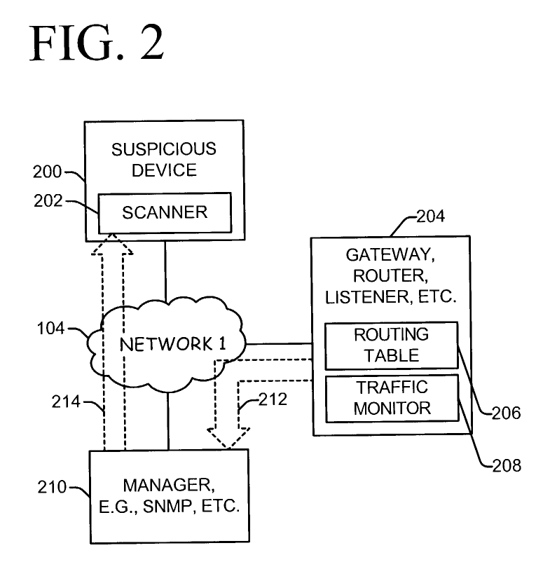

FIG. 2 illustrates one embodiment of a variation of the FIG. 1 embodiment. As illustrated, a suspicious device 200 incorporates a scanner 202, such as a virus scanner or other program configured to search for and fix or remove malicious programs such as worms, viruses, etc. from the infected device. As discussed above for FIG. 1, an intermediary 204 contains a routing table 206 and traffic monitor 208 that monitors for suspicious communication based at least on communication attempts, e.g., attempts to contact addressees not found in the routing table.

However, in this embodiment, a separate manager 210, such a device configured to issue SNMP or other management requests, is communicatively coupled with the intermediary and the suspicious device. In the illustrated embodiment, if the traffic monitor 208 identifies the suspicious device 200, the intermediary 204 sends the manager a notification 212, and the manager in turn send a management instruction 214 to the suspicious device. As discussed above for FIG. 1, the management instruction may be to wholly or partially shut down the suspicious device, or it may be an instruction that the suspicious device execute a particular application program, such as the scanner 202 or other application program that may be capable of cleaning the suspicious device.

Also, for example, the intermediary 204 may stop routing some or all network traffic from the suspicious device 200 pending operation of the scanner 202. IF the scanner indicates successful cleaning, then intermediary may continue routing traffic from the once suspicious device. However, if the traffic monitor 208 again identifies the once suspicious device again, which may occur on a false positive from the scanner, the suspicious device may be managed by the manager 210 again. It will be appreciated that various management approaches may be taken, such as a tiered approach of attempting scanning/cleaning first, and if unsuccessful, then disabling a component of the device that appears to be infected, e.g., an infected web server, and ultimately powering off the infected device if the other solutions do not appear to be effective. In one embodiment, repeated identification of suspicious activity, without an exception being available for a device, results in an alert being sent to a network administrator, and a refusal by the intermediary to pass any network traffic for the suspicious device irrespective of a scanner indicating success.

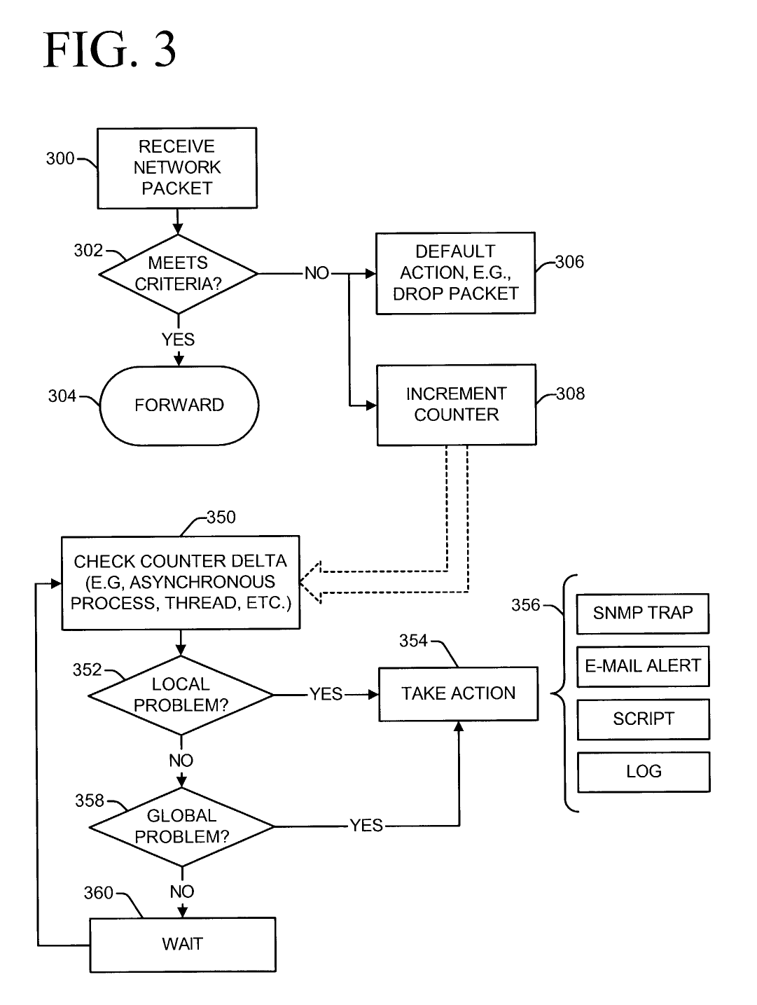

FIG. 3 illustrates a flowchart according to one embodiment for monitoring network communication for suspicious activity. After an intermediary receives 300 a network packet, e.g., by a router, hub, gateway, packet sniffer, etc. Assuming the intermediary operates as a router, a test 302 is performed to determine whether the packet meets forwarding criteria. In one embodiment, the test evaluates whether the packet is addressed to an address known in the intermediary's routing table. If so, the packet is forwarded 304 (routed) onwards.

In one embodiment, only certain types of packets are considered. For example, in one embodiment, only packets used to begin a TCP/IP (Transmission Control Protocol/Internet Protocol) session, e.g., those having their SYN bit set, are inspected for a valid address. In another embodiment, only packets destined for a particular communication port, e.g., ports used by commonly available server services, such as port 80 for an Internet web server, port 23 for a telnet session, port 21 for a File Transfer Protocol session, port 25 for electronic mail, are inspected. It will be appreciated that one or more of the destination address, SYN bit, port, or other packet attribute may be used to select packets or packet types for evaluation.

If the test 302 indicates the packet does not meet the forwarding criteria, then, as illustrated, at least two operations occur. The first is that a default action 306 for the packet is taken. Typically, the default action for a packet addressed to an unknown address is that the packet is dropped. It will be appreciated that another action may be taken depending on the particular tested 302 criteria that was not met. An other operation is incrementing a counter 308 that counts the number of times packets have been received that had an invalid destination address, or that failed some other criteria being tested 302.

Asynchronously, e.g., through a separate process or execution thread, periodically the counter is checked 350. A test 352 is performed to determine whether there is a local problem. In the illustrated embodiment, a local problem indicates that the counter delta, e.g., the difference between the previously checked counter and the present counter value, exceeds a predetermined threshold. It will be appreciated that the threshold may be a static value, such as 10 per second, or a dynamic value that changes depending on various circumstances, including based on the number of detected suspicious devices. Thus, for example, if it is determined that a particular device has issued 25 connection requests to invalid addresses, the particular device may be deemed suspicious, and appropriate action taken 354. It will be appreciated that various actions 356 may be taken, including utilizing a SNMP trap to manage an infected device, wholly or partially disabling the infected device, sending an electronic mail alert to a responsible party, executing a script or other program, logging the error, or taking other action

If the test 352 does not indicate a local problem, then another test 358 is performed to determine whether there is a global problem. Assuming there are other communicatively coupled intermediaries, in one embodiment, the intermediaries share data concerning packets that do not meet related forwarding criteria. Thus, while a particular intermediary may not identify a problem local to the intermediary, a comparison between intermediaries may indicate a global problem related to errors seen by multiple intermediaries. If a problem is identified, then action is taken 354.

If no local or global problems are identified, then in one embodiment, execution waits 360 a desired amount of time, thus setting the period in which the counter delta is evaluated.

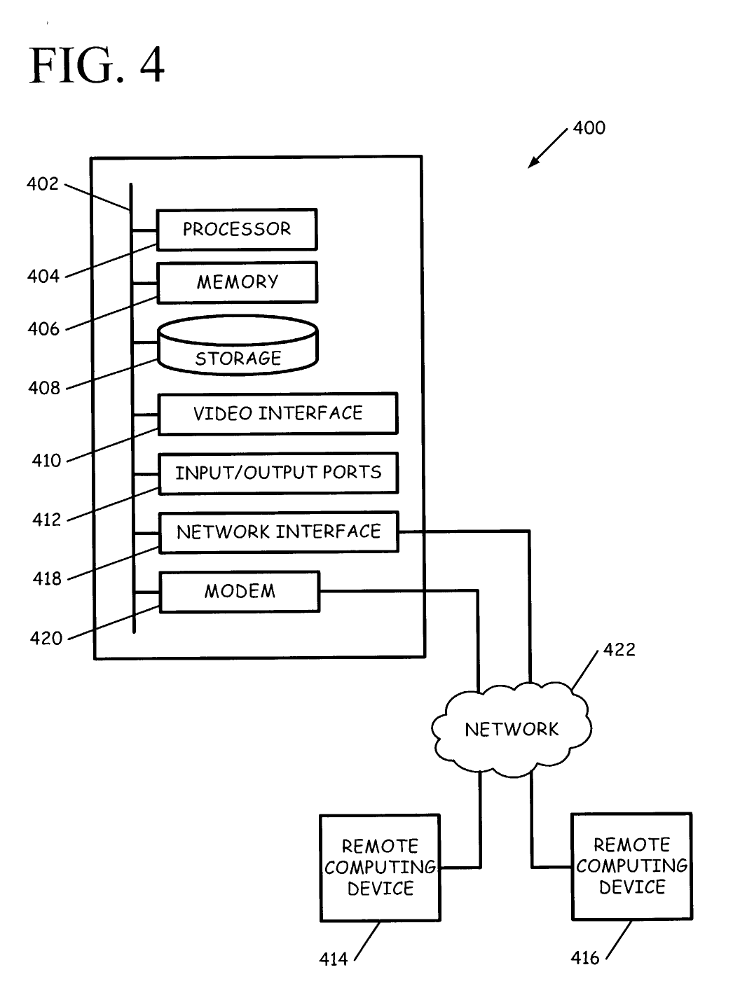

FIG. 4 and the following discussion are intended to provide a brief, general description of a suitable computing environment in which certain aspects of the illustrated invention may be implemented.

For example, the illustrated environment includes a machine 400 which may embody the intermediary 108 or suspicious device of FIG. 1. As used herein, the term “machine” includes a single machine, such as a computer, handheld device, etc., or a system of communicatively coupled machines or devices. Typically, the machine 400 includes a system bus 402 to which is attached processors 404, a memory 406 (e.g., random access memory (RAM), read-only memory (ROM), or other state preserving medium), storage devices 408, a video interface 410, and input/output interface ports 412. The machine may be controlled, at least in part, by input from conventional input devices, such as keyboards, mice, joysticks, as well as directives received from another machine, interaction with a virtual reality (VR) environment, biometric feedback, or other input source or signal.

The machine may also include embedded controllers, such as Generic or Programmable Logic Devices or Arrays, Application Specific Integrated Circuits, singlechip computers, smart cards, or the like, and the machine is expected to operate in a networked environment using physical and/or logical connections to one or more remote machines 414, 416 through a network interface 418, modem 420, or other data pathway. Machines may be interconnected by way of a wired or wireless network 422, such as the networks 104, 106 of FIG. 1, an intranet, the Internet, local area networks, and wide area networks. It will be appreciated that network 422 may utilize various short range or long range wired or wireless carriers, including RF (Radio Frequency), cellular, cable, laser, satellite, microwave, Bluetooth, optical, and infrared.

The invention may be described by reference to or in conjunction with program modules, including functions, procedures, data structures, application programs, etc. for performing tasks, or defining abstract data types or low-level hardware contexts. Program modules may be stored in memory 406 and/or storage devices 408 and associated storage media, e.g., hard-drives, floppy-disks, optical storage, magnetic cassettes, tapes, flash memory cards, memory sticks, digital video disks, biological storage. Program modules may be delivered over transmission environments, including network 422, in the form of packets, serial data, parallel data, propagated signals, etc. Program modules may be used in a compressed or encrypted format, and may be used in a distributed environment and stored in local and/or remote memory, for access by single and multi-processor machines, portable computers, handheld devices, e.g., Personal Digital Assistants (PDAs), cellular telephones, etc.

Thus, for example, with respect to the illustrated embodiments, assuming machine 400 embodies the intermediary 108 of FIG. 1, then remote machines 414, 416 may respectively be the suspicious device 100 and clean device 102. It will be appreciated that remote machines 414, 416 may be configured like machine 400, and therefore include many or all of the elements discussed for machine.

Having described and illustrated the principles of the invention with reference to illustrated embodiments, it will be recognized that the illustrated embodiments can be modified in arrangement and detail without departing from such principles. And, though the foregoing discussion has focused on particular embodiments, other configurations are contemplated. In particular, even though expressions such as “in one embodiment,” “in another embodiment,” or the like are used herein, these phrases are meant to generally reference embodiment possibilities, and are not intended to limit the invention to particular embodiment configurations. As used herein, these terms may reference the same or different embodiments that are combinable into other embodiments.

Consequently, in view of the wide variety of permutations to the embodiments described herein, this detailed description is intended to be illustrative only, and should not be taken as limiting the scope of the invention. What is claimed as the invention, therefore, is all such modifications as may come within the scope and spirit of the following claims and equivalents thereto.

What is claimed is:

1. A method for a first device to process receiving network packets comprising:
tracking a rate at which network packets are received from a second device violating a validity metric, the validity metric including whether received network packets are addressed to a valid destination address;
determining a problem exists with the second device based at least in part on whether the rate exceeds a threshold; and
performing an action responsive to determining the problem.

2. The method of claim 1, wherein the action comprises:
configuring the second device to stop sending network packets.

3. The method of claim 1, wherein the action comprises:
identifying a program executing on the second device associated with the network packets that violate the validity metric; and
configuring the second device to stop the program.

4. The method of claim 1, wherein the action comprises:
identifying a communication port associated with the network packets received from the second device that violate the validity metric; and
dropping packets received from the second device using the communication port.

5. The method of claim 1, wherein the action is selected ones of: issuing a SNMP trap, sending an e-mail alert, executing a script, and logging the problem.

6. The method of claim 1, wherein the rate comprises receiving from the second device at least 10 network packets per second violating the validity metric.

7. The method of claim 1, wherein the rate corresponds to an aggregate measure of network packets that violate the validity metric received the second device and at least one other device.

8. The method of claim 1, further comprising:
determining the problem asynchronously to the receiving network packets.

9. The method of claim 1, further comprising:
a third device performing the determining the problem.

10. The method of claim 1, further comprising:
a first module performing the receiving the network packets; and
a second module performing the determining the problem asynchronously to the first program module.

11. The method of claim 1, further comprising:
tracking only a subset of received network packets.

12. The method of claim 11, further comprising:
determining the subset based at least in part on received network packets having selected ones of the following characteristics: being a communication session initiation packet, utilizing a particular communication port, and having a particular origin address.

13. The method of claim 1, further comprising:
forwarding a received packet to a third device.

14. The method of claim 1, further comprising:
dropping a received packet violating the validity metric.

15. A method for processing network packets comprising:
determining a first rate at which network packets are received from a first originating device that violate a validity metric;
accessing a second rate determined for network packets received by an other device from a second originating device that violate the validity metric;
determining a problem exists with the originating device based at least in part on a combination of the first and second rates; and
performing an action responsive to determining the problem.

16. The method of claim 15, wherein determining the problem comprises:
determining whether an addition of the rates exceeds a threshold

17. The method of claim 15, wherein the first and second originating device are communicatively coupled.

18. The method of claim 15, wherein the validity metric comprises determining whether received network packets are addressed to a valid destination address.

19. The method of claim 15, wherein the action comprises:
configuring the second device to stop sending network packets.

20. The method of claim 15, wherein the action comprises:
identifying a program executing on both the first and second originating device associated with the network packets that violate the validity metric; and
instructing one of the first or second originating devices to stop the program.

21. The method of claim 15, wherein the action comprises:
identifying a communication port associated with the network packets received from the first and second originating device that violate the validity metric; and
dropping packets received from the second device using the communication port.

22. The method of claim 15, wherein the action is selected ones of: issuing a SNMP trap, sending an e-mail alert, executing a script, and logging the problem.

23. The method of claim 15, further comprising:
determining the problem asynchronously to determining the first rate and accessing the second rate.

24. The method of claim 15, further comprising:
tracking by the first and second devices of only a subset of network packets received thereto; and
determining the subset based at least in part on received network packets having selected ones of the following characteristics: being a communication session initiation packet, utilizing a particular communication port, and having a particular origin address.

25. An article, comprising a machine-accessible media having associated data for directing a machine to process network packets, wherein the data, when accessed, results in the machine performing:
tracking a rate at which network packets are received from a device violating a validity metric;
determining a problem exists with the device based at least in part on whether the rate exceeds a threshold; and
performing an action responsive to determining the problem.

26. The article of claim 25 wherein the machine-accessible media further includes data, which when accessed by the machine, results in the machine performing:
determining whether received network packets are addressed to a valid destination address.

27. The article of claim 25 wherein the data for performing the action further includes data, which when accessed by the machine, results in the machine performing:
configuring the device to stop sending network packets.

28. The article of claim 25 wherein the data for performing the action further includes data, which when accessed by the machine, results in the machine performing:
identifying a program executing on the device associated with the network packets that violate the validity metric; and
configuring the device to stop the program.

29. The article of claim 25 wherein the data for performing the action further includes data, which when accessed by the machine, results in the machine performing:
identifying a communication port associated with the network packets received from the device that violate the validity metric; and
dropping packets received from the device using the communication port.

30. The article of claim 25 wherein the data for performing the action further includes data, which when accessed by the machine, results in the machine performing:
issuing a SNMP trap;
sending an e-mail alert;
executing a script; and
logging the problem.

31. The article of claim 25 wherein the machine-accessible media further includes data, which when accessed by the machine, results in the machine performing:
determining the problem asynchronously to the receiving network packets.

32. The article of claim 25 wherein the machine-accessible media further includes data, when accessed by the machine, results in the machine performing:
tracking only a subset of received network packets.

33. An article, comprising a machine-accessible media having associated data for processing network packets, wherein the data, when accessed, results in a machine performing:
determining a first rate at which network packets are received from a first originating device that violate a validity metric;
accessing a second rate determined for network packets received by an other device from a second originating device that violate the validity metric;
determining a problem exists with the originating device based at least in part on a combination of the first and second rates; and
performing an action responsive to determining the problem.

34. The article of claim 33 wherein the data for determining the problem includes further data, which when accessed by the machine, results in the machine performing:
determining whether an addition of the rates exceeds a threshold

35. The article of claim 33 wherein the machine-accessible media further includes data, when accessed by the machine, results in the machine performing:
determining whether received network packets are addressed to a valid destination address.

36. A system for processing network packets comprising:
a network interface configured to receive network packets; and
a machine communicatively coupled to the network interface and configured to perform:
tracking a rate at which network packets are received from a device violating a validity metric, the validity metric including whether received network packets are addressed to a valid destination address;
determining a problem exists with the device based at least in part on whether the rate exceeds a threshold; and
performing an action responsive to determining the problem.

37. The system of claim 36, wherein the machine is further configured to perform:
determining whether network packets received by the network interface are addressed to a valid destination address.

38. The system of claim 36, wherein the action taken by the machine comprises performing:
managing the device
